(19) United States
(12) Patent Application Publication
(10) Pub. No.: US 2005/0176278 A1
(43) Pub. Date: Aug. 11, 2005

(54) Sliding clip electrical connection box mounting bracket

(76) Inventors: James F. Cheatham, Palos Verdes, CA (US); Fred Milne, Huntington Beach, CA (US)

Correspondence Address: Brian F. Drazich;COUDERT BROTHERS LLP, 23rd Floor, 333 South Hope Street, Los Angeles, CA, 90071, US

(21) Appl. No.: 11/028,252

(22) Filed: Dec. 30, 2004

Related U.S. Application Data
(60) Provisional application No. 60/533,499, filed on Dec. 31, 2003.

(51) Int. Cl. H01R 4/66

(52) U.S. Cl. 439/92

(57) ABSTRACT

Electrical box mounting bracket for use in mounting electrical connection boxes between structural members in walls, floors or ceilings, such as, for example, between wall studs, ceiling joists or floor joists, separated by predetermined distances, such as 16 inches, 24 inches, or other distances, having mounting screw hole locations and orientations designed to permit mounting of standard 4 inch and 4 11/16 inch electrical connection boxes to the bracket at any location between the two ends of the bracket and which provides for closure of the gap or additional unused opening area which typically exists between the box cover and the two sidewall edges of the connection box that span the width of the bracket frame. The sides of the bracket may be of fixed length or have a sliding relationship so that the length of the bracket from end to end may be adjusted. Further an electrical connection box and bracket are provided that allows the electrical connection box to be initially attached to the bracket without the use of screws or other separate fasteners, to facilitate the installation—or “pulling”—of electrical wiring. It is emphasized that this abstract is provided to comply with the rules requiring an abstract that will allow a searcher or other reader to quickly ascertain the subject matter of the technical disclosure. It is submitted with the understanding that it will not be used to interpret or limit the scope of the claims.

### CROSS REFERENCE TO RELATED APPLICATIONS

This application claims the benefit of U.S. Provisional Application Ser. No. 60/533,499 filed Dec. 31, 2003, which is incorporated herein by reference.

### BACKGROUND OF THE INVENTION

A. Field of the Invention

The present invention is directed to mounting brackets used for mounting or supporting electrical connection boxes.

B. Description of the Prior Art

Various types of brackets used for mounting or supporting electrical connection boxes are known. For example, U.S. Pat. No. 5,330,137 (the '137 patent) to Oliva describes apparatus and method for mounting an electrical box between studs in a wall. Embodiments of the present invention include improvements to the mounting brackets as described in the '137 patent, which is incorporated by reference herein. The mounting bracket of the '137 patent is of a unitary construction, having an open face, and is of a length of either 16 or 24 inches, to accommodate the distance typically separating wall studs used in the construction industry.

Another type of conventional mounting bracket, or electrical fastener used for supporting electrical connection boxes does not have an open face, but rather has three or four pre-designated slots, or open spaces for mounting three or four electrical boxes at precise, predetermined locations. These mounting brackets are commonly referred to as “box mounting brackets” and are available from numerous sources, such as Raco; Thomas & Betts as its “Steel City” brand electrical fastener; Cooper as its “B-Line” brand electrical fastener; and Caddy, as its model RBS 16 electrical fastener for accommodating three electrical boxes, or its model RBS 24 fastener for accommodating four electrical boxes. These brackets include pairs of holes positioned at predetermined locations for precise positioning of large electrical boxes and/or large electrical box covers. As with the mounting brackets of the '137 patent, the RBS 16 and RBS 24 type brackets are of a unitary construction. Also, single bar brackets, both fixed and adjustable are know, as shown and described in U.S. Pat. No. 4,757,967 and U.S. Pat. No. 5,386,959.

None of the existing adjustable brackets used for mounting electrical connection boxes allow the position of the connection box—between the two ends of the bracket—to be selected at the time of installation. None of the existing adjustable brackets used for mounting electrical connection boxes minimize the additional fire leak path from the interior of a connection box created upon the installation of a standard size connection box and matching cover. Further, none are designed to comply with current Underwriters Laboratories criteria for fire safety, which presently allows a maximum unused opening area of 0.2 square inches for each face of a connection box.

### SUMMARY OF THE INVENTION

With the objectives of improving conventional mounting brackets, reducing the cost of manufacture of mounting brackets for electrical boxes, and providing novel functionality for mounting brackets for electrical boxes in comparison to conventional mounting brackets, the present invention includes features for mounting brackets for electrical boxes that are manufactured from discreet pieces, and then joined and fabricated into a mounting bracket that is adjustable to allow the location of a connection box, between the two ends of the bracket, to be selected at the time of installation of a connection box and which provides for the installation of a ganged connection box.

In yet another alternate embodiment, the sides or rails of the bracket are fabricated to have a telescoping or sliding relationship so that the length of the bracket from end to end may be adjusted. The result includes significant savings of cost of manufacture of such brackets; adjustability of the length of the mounting brackets so that a single mounting bracket may be used to accommodate any of a conventional 16-inch, a 24-inch distance, or 24-inch distance, such as, for example an 11-inch distance or greater distances such as a 27-inch distance.

It is an object of the present invention to comply with Underwriters Laboratories criteria for fire safety by providing a mount that minimizes any additional fire leak paths, or additional unused opening area, when a standard (i.e., 4″ and 4 11/16″ square conventional electrical connection box) electrical connection box and standard box cover are installed on the bracket.

It is a further object of the present invention to provide an electrical connection box and bracket which allows the electrical connection box to be initially attached to the bracket, at any location between the two ends of the bracket, without the use of screws or other separate fasteners.

It is yet a further object of the present invention to provide an electrical connection box and bracket which allows the electrical connection box to be initially attached to the bracket without the use of screws or other separate fasteners, to facilitate the installation—or “pulling”—of electrical wiring to or through the connection box.

It is a further object of the present invention to provide an electrical connection box and bracket which allows the electrical connection box to be attached to the bracket at any location between the two ends of the bracket and which provides for closure of the opening or gap which typically exists between the box cover and the two sidewall edges of the connection box that are not in contact with either of the two lengthwise bracket frame members when the connection box and matching cover are installed on the bracket.

It is a further object of the present invention to provide a bracket which provides a plurality of connection box mounting holes, or screw holes, none of which holes span or extend across the top surface of the sidewall of the connection box when a standard electrical connection box and matching cover are installed on the bracket.

It is an additional object of the present invention to provide a bracket which provides that at least a portion of the width of the top surface of the connection box sidewall is in contact with a surface of the bracket at each point along the length of the top surface except at those locations where the top surface has been manufactured as a mounting screw hole tab.

It is an additional object of the present invention to provide a bracket which creates minimal additional unused opening area when a standard electrical connection box and matching cover are installed on the bracket.

It is an additional object of the present invention to provide a bracket which creates minimal additional fire leak path when a standard electrical connection box and matching cover are installed on the bracket.

### BRIEF DESCRIPTION OF THE DRAWINGS

FIG. 1 is a front view of a first embodiment of the present invention bracket having a fixed frame.

FIG. 2 is a side view of the FIG. 1 embodiment.

FIGS. 3 is a first end view of the FIG. 1 embodiment.

FIG. 4 is a second end view of the FIG. 1 embodiment.

FIG. 5 is a front view of a slider clip of the present invention bracket.

FIG. 6 is a side view of a slider clip of the present invention bracket.

FIG. 7 is an end view of a slider clip of the present invention bracket.

FIG. 8 is a front view of an alternative FIG. 1 embodiment having one sliding clip showing the outline of a mounting position of a “ganged” connection box.

FIG. 9 is a side view of the FIG. 8 embodiment.

FIG. 10 is an end view of the FIG. 8 embodiment.

FIG. 11 is a front view of another alternative FIG. 1 embodiment having two sliding clips showing the outline of a mounting position of two connection boxes.

FIG. 12 is a side view of the FIG. 11 embodiment.

FIG. 13 is an end view of the FIG. 11 embodiment.

FIG. 14 is a front view of a second embodiment of the present invention bracket having an adjustable length frame, and with two sliding clips.

FIG. 15 is a side view of the FIG. 14 embodiment.

FIG. 16 is an end view of the FIG. 14 embodiment.

FIG. 17 is front view of the FIG. 14 embodiment showing the outline of a mounting position of three connection boxes.

FIG. 18 is a side view of the FIG. 17 embodiment.

FIG. 19 is an end view of the FIG. 17 embodiment.

FIG. 20 is a front view of an alternative FIG. 1 embodiment in which the frame and a sliding clip are not notched to accommodate mounting screws, showing the outline of a possible mounting position of a “small” and “large” connection box.

FIG. 21 is a side view of the FIG. 20 embodiment.

FIG. 22 is an end view of the FIG. 20 embodiment.

FIG. 22A is a cross-sectional view through the bracket and sliding clip cut along the centerline of the sliding clip of the FIG. 20 embodiment.

FIG. 23 is a detailed cross-sectional view of the FIG. 22A embodiment showing a possible configuration of the mating relation between the sliding clip and the bracket frame.

FIG. 24 is a front view of a first embodiment of the present invention electrical connection box having tabs for initial attachment to a mounting bracket and a raised wall portion between the tabs.

FIG. 25 is a side view of the FIG. 24 embodiment showing tabs for initial attachment to a mounting bracket and a raised sidewall portion between the tabs.

FIG. 26 is a front view of a second embodiment of the present invention electrical connection box having a raised central portion of the sidewall.

FIG. 27 is a side view of the FIG. 26 embodiment showing a raised central portion of the sidewall.

### DESCRIPTION OF EMBODIMENTS OF THE INVENTION

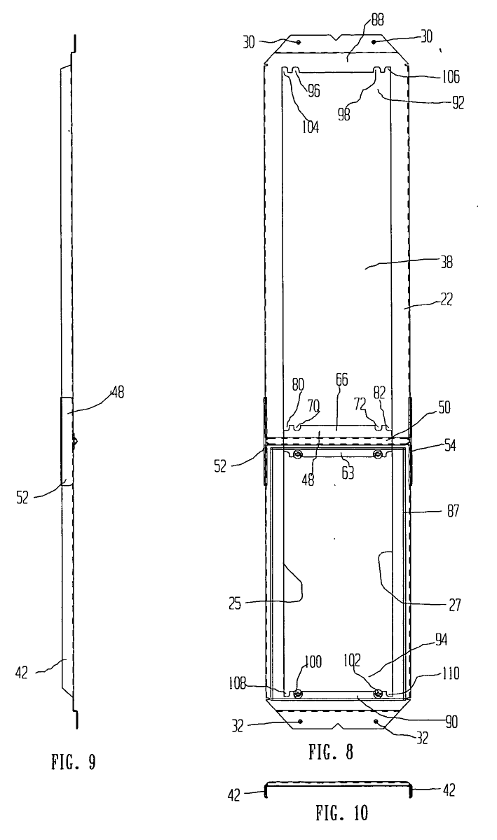

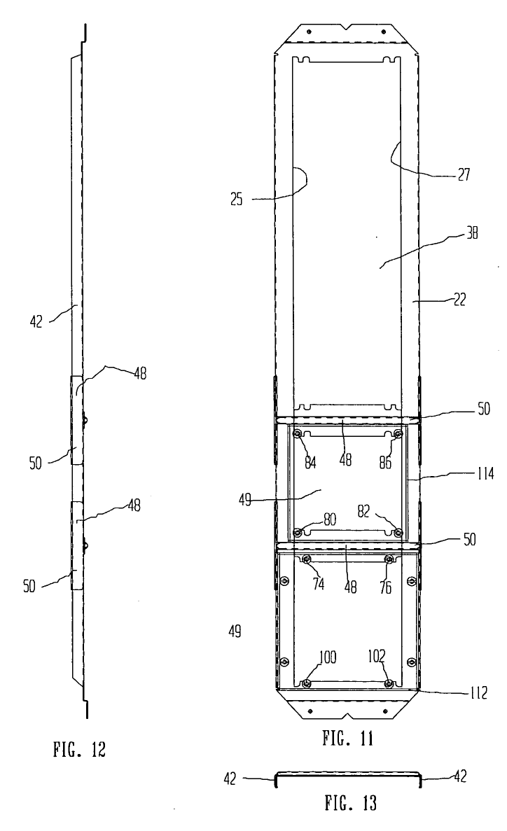

In general, the present invention is directed to improved brackets for use in mounting electrical boxes to structural members in walls, floors and ceiling, such as studs in walls of buildings or joists in floors or ceilings. Referring to FIGS. 1-4, a first embodiment of the present invention will be described. The embodiment of FIGS. 1-4 is directed to a bracket that is made from a single unitary piece of flat stock, in the alternative the mounting bracket may be made from component parts that are assembled into a finished, or completed mounting bracket. As is well known, a conventional, type bracket is manufactured from a single piece of material, such as metal and as described in the '137 patent. The mounting bracket of FIGS. 1-27 includes novel features that provide additional functionality and that are significant improvements over the mounting brackets described in the '137 patent and elsewhere in the prior art. With reference to FIGS. 1-27, like numbers describe like parts.

Referring to FIG. 1, the bracket 20 is of a substantially flat and elongated frame 22. Frame 22 is constructed of relatively rigid material, preferably of a metal such as 20 gauge galvanized sheet metal. Also, other materials may be used, including extruded materials such as plastics or extruded metals, for example aluminum; die-cast materials, for example zinc or aluminum; stamped materials, for example aluminum or certain plastics; injection molded materials, for example plastics; and composite materials, all of which are presently known in this field. The bracket includes a back planar face 21 and an opposite front planar face 24. The bracket also includes a first end 26, and a second, opposing end 28, with each end having at least one hole 30, 32 for attaching the frame 22 to a corresponding wall stud. At each end, surface 34, 36 is elevated above the front face 24 of the frame for the reasons described in the '137 patent.

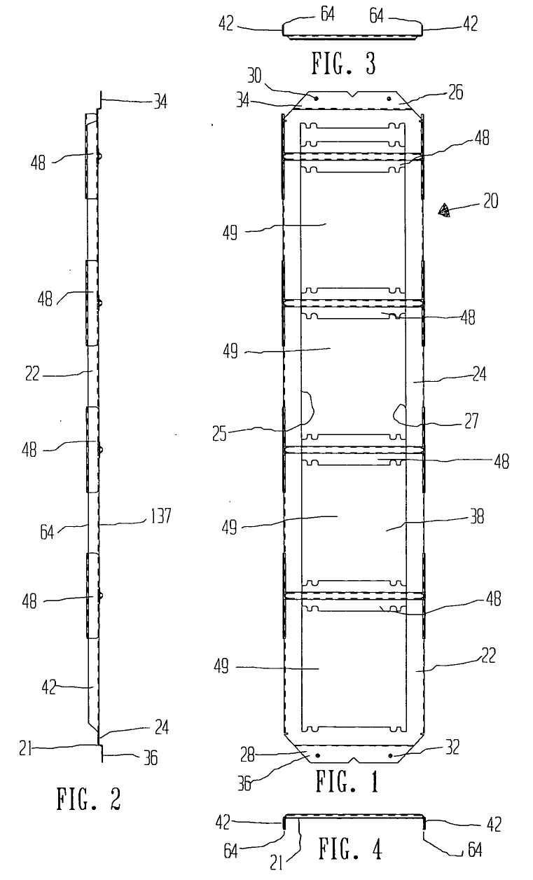

To enhance the structural rigidity of the frame 22, the lengthwise edges of the frame 22 are preferably bent away from front surface 24 at a substantially right angle, to form a lips 42, which are shown in dashed lines FIG. 1 and in solid lines in FIG. 2, and both of which are shown in solid lines in FIGS. 3 and 4. The present invention may also use one or more sliding clips 48 to define a plurality of connection box mounting openings 49.

With reference to FIG. 2, the elevated surfaces 34, 36 at ends 26, 28 are shown in relation to the lips 42. The thickness of the material is shown with reference to dashed line 137.

Also, with reference to FIGS. 1-4, the bracket 20 of the present invention includes a central cut-out portion, or opening, 38 made by punching, stamping or otherwise removing material from the center of the work piece that would correspond to the cut-out portions or opening 38 that extends substantially along the majority of the length of frame 22, and which opening 38 is subdivided into a plurality of connection box mounting openings 49 by one or more sliding clips 48. Alternatively, the present invention may be manufactured from component parts, and then assembled or joined to form a frame 22 which has a cut-out portion, or opening, 38. The opening 38 is preferably centered midway between the lengthwise inner edges of the frame 22. The lengthwise inner edges 25, 27 of the frame 22 preferably are separated by a distance of less than about 3.87 inches.

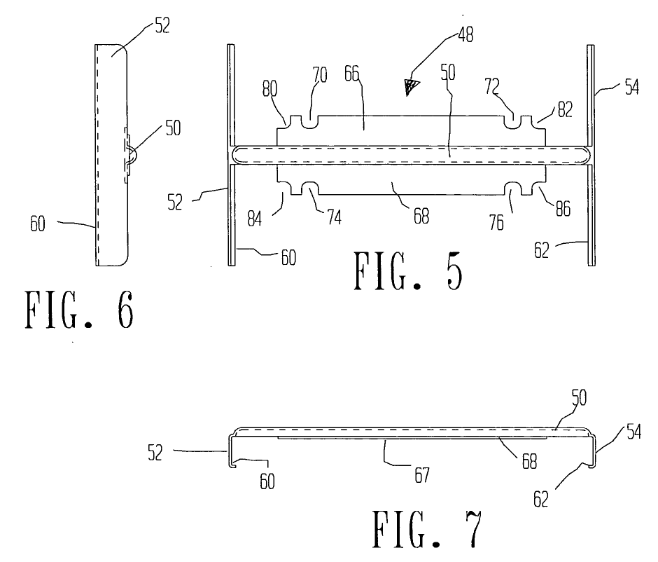

With reference to FIGS. 5-7, one embodiment of a sliding clip 48 is shown. Sliding clip 48 has a cross member 50 and two end members 52, 54. Sliding clip 48 is preferably formed of a single piece of stock by stamping or otherwise shaping and bending. Alternatively, the sliding clip 48 may be manufactured from component parts, and then assembled or joined together. The end members 52, 54 are formed essentially orthogonal to cross member 50 and are shaped so that their inner surfaces 56, 58 to conform to the outer surfaces of lips 42. End members 52, 54 each include a lip 60, 62, respectively. Inner surfaces 56, 58 of clip 48 are thus adapted to a sliding relationship with the outer surfaces of lips 42 of frame 22 such that clip 48 will slide along frame 22 to any selected position. Sliding clip 48 is retained on frame 22 by lips 60, 62 which extend over the edge 64 of each lip 42 of the frame 22.

With further reference to FIGS. 5-7, substantially planar screw tabs 66, 68 extend from opposite sides of cross-member 50 have a bottom surface 67 for contacting the top edge of the connection box sidewalls that span the width of the opening 38. The connection box sidewalls are known to have a typical wall thickness of about 0.062 inches. Screw tabs 66, 68 extend substantially along the central portion of cross-member 50. Notches 70, 72; 74, 76 formed in screw tabs 66, 68, respectively, are each positioned and adapted to accept the shank of a connection box mounting screw for mounting a standard 4 11/16 inch square (“large”) electrical connection box or a “ganged” electrical connection box having a width of 4 11/16 inches (outside dimension) and a longer length. Similarly, notches 80, 82, 84, 86 formed in screw tabs 66, 68, respectively, are each positioned and adapted to accept the shank of a connection box mounting screw for mounting a standard 4 inch square (“small”) electrical connection box or a “ganged” electrical connection box having a width of 4 inches (outside dimension) and a longer length.

Now referring to FIGS. 8-10, the first embodiment of the present invention is shown with the position of only a single “large” 4 11/16 inch width “ganged” or rectangular “multiple” connection box 87 outlined for clarity. The frame 22 cross-members 88, 90 define the two ends 92, 94 of central opening 38. Notches 96, 98 and 100, 102 (shown with screws installed) formed in cross-members 88, 90, respectively, are each positioned and adapted to accept the shank of a connection box mounting screw for mounting a standard “large” electrical connection box or a “ganged” electrical connection box having a width of 4 11/16 inches (outside dimension) and a longer length. Similarly, notches 104, 106 and 108, 110 formed in cross-members 88, 90, respectively, are each positioned and adapted to accept the shank of a connection box mounting screw for mounting a standard 4 inch square (“small”) electrical connection box or a “ganged” electrical connection box having a width of 4 inches (outside dimension) and a longer length.

Referring to FIGS. 11-13, the first embodiment of the present invention is shown with the position of a “large” 4 11/16 inch square connection box 112 and the position of a “small” 4 inch square connection box 114 outlined for clarity. The “large” connection box 112 is shown with screw holes 74, 76, 100 and 102 occupied by screws. The “small” connection box 114 is shown with screw holes 80, 82, 84 and 86 occupied by screws.

While the embodiment of FIGS. 1-4 and 8-13 is shown using one piece, it is within the scope of the present invention that the bracket could be made of other numbers of components, with each component affixed to the other with conventional techniques such as mechanical techniques and welding techniques. Useful mechanical fasteners include those known as bonded, crimped, fold-tab, rivet, self-riveting, screw, bolt, staking and toggle-lock. Useful welding techniques include those known as projection, spot, tig, mig, stick and gas. For example, brackets being made of two pieces, three pieces, four, five, six or more, can be made and all are considered to be within the scope of the present invention. Alternatively, the shapes of the various components could be altered as well. In addition, other conventional sliding type constructions may be used with the present invention, and all conventional sliding type constructions may be used with the present invention, and all operable such types of sliding mechanisms are considered to be within the scope of the present invention.

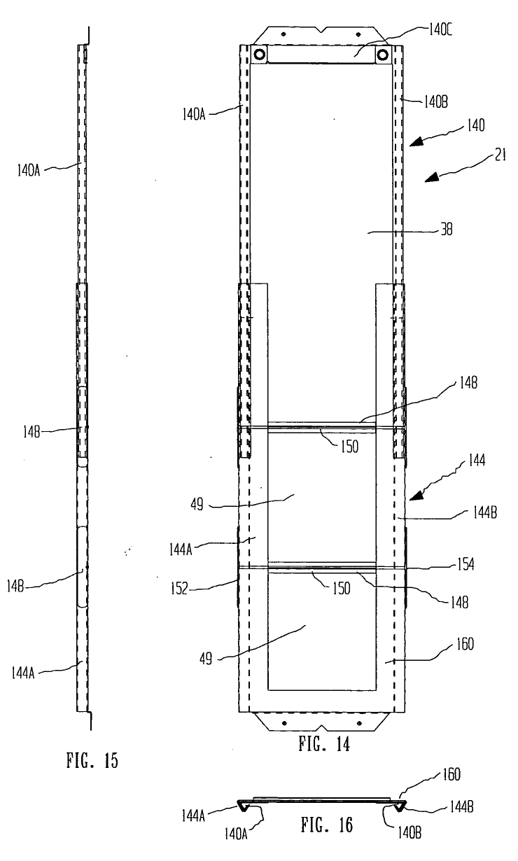

Referring now to FIGS. 14-16, a second embodiment of the present invention will be described and referred to as the adjustable mounting bracket 21. In general, the second embodiment of the present invention is directed to a bracket for mounting electrical boxes that is made to be adjustable in length, but is also optionally, made of two single mating pieces or of component parts, to save in cost of manufacture. By incorporating the features of this embodiment, a single mounting bracket may be adjusted to be used with structural members, such as wall studs that are typically separated by a distance of either 16 or 24 inches, or, by other, unconventional distances between studs.

However, as will be described in greater detail, the sliding rail portion 140 of the bracket 21 may be made in separate pieces 140A, 140B and 140C and is constructed so as to have a sliding or telescoping relationship with integrally formed track section 144 of bracket 21. As shown, for example, in FIGS. 14-16, the pair of rails 140A, 140B are fashioned to slide within the pair of tracks 144A, 144B so that varying distances between structural members, such as wall studs, may be accommodated. As shown in FIG. 14, this second embodiment of the present invention provides for installation of up to three connection boxes.

Shown in FIG. 16 is an end view of the rail sections 140A and 140B, with a folded over portion having preferably a substantially triangular cross-section of small enough area such that the rail sections 140A, 140B slide within the tracks 144A, 144B of track section 144, which have a substantially triangular cross-section sized and shaped to accept rail sections 140A and 140B, respectively. Other cross-sections for the mating rails and tracks such as circular or rectangular may be used and are within the scope of the present invention. Optionally, adjustable bracket 21 may be used with sliding clips 148, two of which are shown in FIG. 14, with their end members 152, 154 bent back to form an acute angle with the cross-member 150 of sliding clip 148. The acute angle formed between the end members 152, 154 and the cross-member 150 matches the angle formed between tracks 144A, 144B and face 160 of track section 144, so that a sliding clip 148 may be retained on and slid along track section 144. As shown in FIG. 14, sliding clips 148 may define one or more connection box mounting openings 49 in each of which a connection box of 4 inch or 4 11/16 inch width may be installed with matching covers.

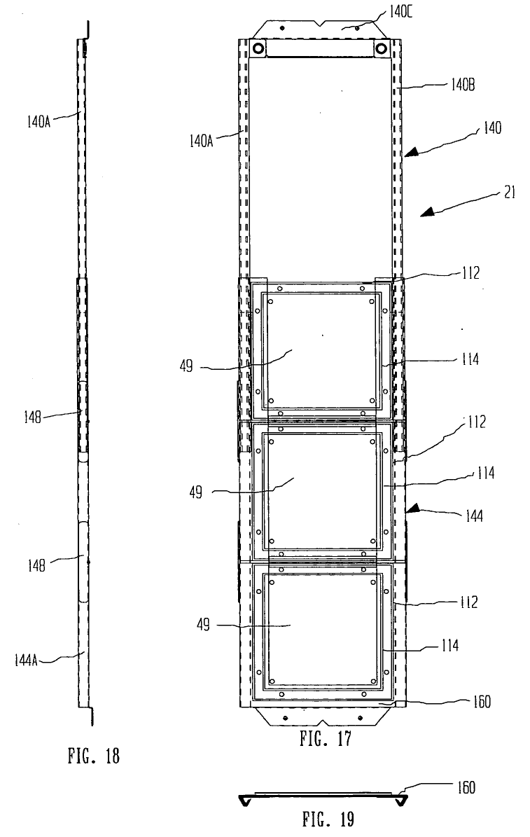

With reference now to FIGS. 17-19, the second embodiment of the present invention described with reference to FIGS. 14-16 is shown with three positions for a “large” square connection box 112 and three positions for a “small” square connection box 114 outlined for clarity.

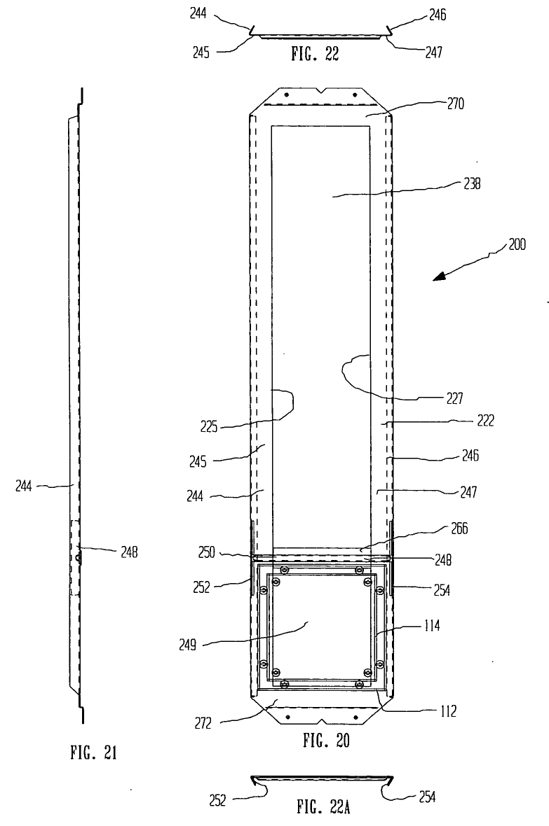

Referring now to FIGS. 20-22A, a third embodiment of the present invention will be described and referred to as a fixed length bracket with sliding clip. In general, the third embodiment of the present invention is directed to a bracket 200 and sliding clip 248 which is adapted to slide in tracks 244, 246 formed by folding back the lengthwise outer edges of frame 222 to create an acute angle with the plane containing inner edges 225, 227 of frame 222. Cross-member 250 of clip 248 extends between end-members 252, 254 which are folded back to match the angle and shape of tracks 244, 246, so that end-members 252, 254, respectively, of clip 248 may be retained in tracks 244, 246, respectively, and slid along frame 222. FIG. 20 shows one sliding clip 248 retained on frame 222 defining a connection box mounting space 249. FIG. 20 also shows in outline, for clarity, the mounting positions of a “large” connection box 112 and a “small” connection box 114 in the mounting space 249 defined by sliding clip 248. It will be understood that a plurality of sliding clips 248 will define a plurality of mounting spaces 249 within central opening 238.

With further reference to FIGS. 20-22A, substantially planar tabs 266 (shown) and 268 (not shown) extend from opposite sides of cross-member 250 and extend along the central portion of cross-member 250 between edges 225 and 227 of frame 222. Tabs 266 (shown) and 268 (not shown) of clip 248 are formed and configured to have the same thickness as frame 222 and to lie in the plane defined by planar side members 245, 247 and planar end-members 270, 272 of frame 222. The edges of the four sections of the sidewall of a connection box 112 or 114 installed over a mounting opening 249 will each contact the substantially planar surface of one of the frame members 245, 247 and 272 and sliding clip tab 268 (not shown); or one of the frame members 245, 247 and 270 and sliding clip tab 266; or one of the frame members 245 and 247 and sliding clip tabs 266 and 268 (not shown). In the FIG. 20 configuration, shown for example, the sidewalls of a connection box 112 or 114 contact frame members 245, 247 and 272 and sliding clip tab 268 (not shown). Thus, because substantially the entire length of each of the four sections of the sidewall of a connection box installed on bracket 200 will be in contact with a member of frame 222 and clip 248, the creation of additional unused openings from the interior of the connection box to the external environment will be minimized or eliminated.

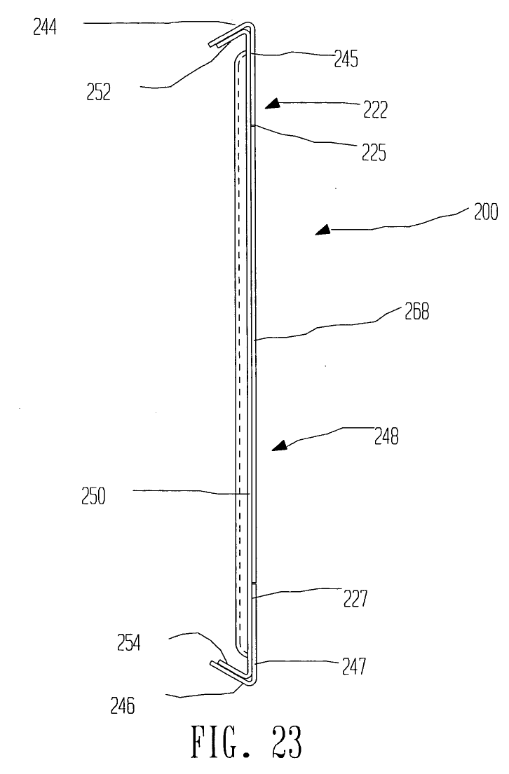

With reference to FIG. 23 a detailed cross-sectional view of the FIG. 20 embodiment is shown. A preferred configuration of the mating relation between the sliding clip 248 and the frame 222 is shown. As described above, tab 268 of clip 248 extends between edges 225 and 227 of frame 222 and lies in the same plane as frame side members 245 and 247. The end-members 252 and 254 nestingly mate in sliding relation with frame tracks 244 and 246, respectively.

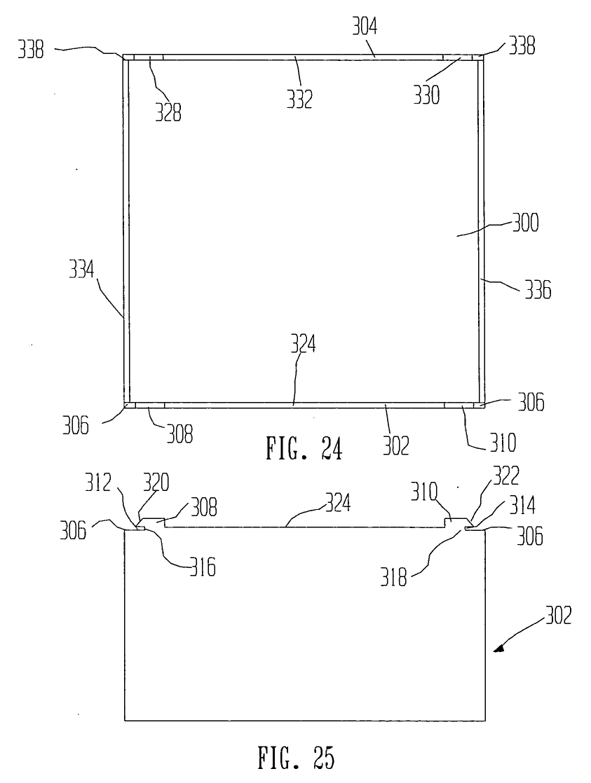

With reference now to FIGS. 24-25, a fourth embodiment of the present invention will be described. In general, the fourth embodiment of the present invention is directed to a connection box that may initially be “snapped” onto, or otherwise attached without the use of screws or other separate fasteners to, connection box mounting brackets, such as shown for example in FIGS. 1, 8, 11, 14, 17 and 20, to facilitate the ease and speed of installation of electrical wiring and the connection box. FIG. 25 shows one of the sidewall portions of the connection box 300 which sidewall portions 302 and 304 are two essentially identical sidewall portions that span the opening between the side members of a frame such as shown in FIGS. 1, 8, 11, 14, 17 and 20.

With continued reference to FIGS. 24-25, sidewall 302 has upper edge surface 306 that is level with the upper edge surfaces of sidewall portions 334, 336 of box 300. Tabs 308, 310 define notches 312, 314, respectively, which terminate at terminal walls 316, 318, respectively. The distance between terminal walls 316 and 318 is slightly less than or about equal to the distance between the two innermost edges of the side members of a frame such as shown in FIGS. 1, 8, 11, 14, 17 and 20. The distance between the opening of notches 312 and 314 is slightly more than the distance between the two innermost edges of the side members of a frame such as shown in FIGS. 1, 8, 11, 14, 17 and 20. Further, the height of notches 312 and 314 is slightly more than the thickness of the side members of a frame such as shown in FIGS. 1, 8, 11, 14, 17 and 20. Beveled surfaces 320, 322 of tabs 308, 310, respectively, facilitate sliding or “snapping” tabs 308 and 310 of sidewall portions 302 and 304 of connection box 300 over the two innermost edges of the side members of a bracket frame such that box 300 is retained on a bracket such as shown in FIGS. 1, 8, 11, 14, 17 and 20, yet may be slid to any selected position along the bracket.

With further reference to FIGS. 24-25, upper edge surfaces 324, 332 extend between tabs 308, 310 and tabs 328, 330, respectively, of sidewall portions 302, 304, respectively. Upper edge surfaces 324, 332 extend a distance above sidewall upper edge surfaces 306, 334, 336 and 338 that is about equal to the thickness of the side members of a frame such as shown in FIGS. 1, 8, 11, 14, 17 and 20, which typically is about the thickness of 20 gauge galvanized sheet metal. When installed on a bracket together with a matching connection box cover, upper edge surfaces 306, 334, 336 and 338 are in contact with the frame side members such as shown for example in FIGS. 1, 8, 11, 14, 17 and 20. Similarly, upper edge surfaces 324 and 332 are in contact with the matching connection box cover. Thus, because substantially the entire length of each of the four sections 302, 304, 334 and 336 of the sidewall of the connection box 300 installed on bracket, such as shown in FIGS. 1, 8, 11, 14, 17 and 20, will be in contact with a surface of the bracket or a surface of the box cover, the creation of additional unused openings from the interior of the connection box to the external environment will be minimized or eliminated.

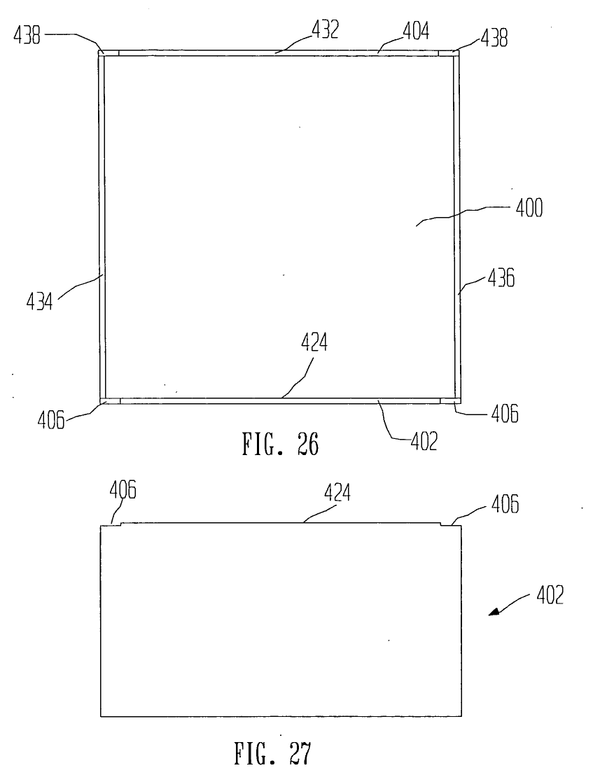

With reference now to FIGS. 26-27, a fifth embodiment of the present invention will be described. In general, the fifth embodiment of the present invention is directed to a connection box that reduces or eliminates creation of additional unused opening area when installed together with a matching cover on a mounting bracket. FIG. 27 shows one of the sidewall portions of the connection box 400 which sidewall portions 402 and 404 are two essentially identical sidewall portions that span the opening between the side members of a frame such as shown in FIGS. 1, 8, 11, 14, 17 and 20.

With continued reference to FIGS. 26-27, sidewall 402 has upper edge surface 406 that is level with the upper edge surface 438 of sidewall portion 404 and the upper edge surfaces of sidewall portions 434, 436 of box 400. With further reference to FIGS. 26-27, upper edge surfaces 424, 432 extend a distance is slightly less than or about equal to the distance between the two innermost edges of the side members of a frame such as shown in FIGS. 1, 8, 11, 14, 17 and 20. Upper edge surfaces 424, 432 extend a distance above the upper edge surfaces 406 and 438 that is about equal to the thickness of the side members of a frame such as shown in FIGS. 1, 8, 11, 14, 17 and 20, which typically is about the thickness of 20 gauge galvanized sheet metal. When installed on a bracket together with a matching connection box cover, upper edge surfaces 406 and 438 are in contact with the frame side members such as shown for example in FIGS. 1, 8, 11, 14, 17 and 20. Similarly, upper edge surfaces 424 and 432 are in contact with the matching connection box cover. Thus, because substantially the entire length of each of the four sections 402, 404, 434 and 436 of the sidewall of the connection box 400 installed on bracket, such as shown in FIGS. 1, 8, 11, 14, 17 and 20, will be in contact with a surface of the bracket or a surface of the box cover, the creation of additional unused openings from the interior of the connection box to the external environment will be minimized or eliminated.

While the present invention has been described in connection with what is presently considered to be the most practical and preferred embodiments, it is to be understood that the invention is not to be limited to the disclosed embodiments, but to the contrary, is intended to cover various modifications and equivalent arrangements included within the spirit of the invention, which are set forth in the appended claims, and which scope is to be accorded the broadest interpretation so as to encompass all such modifications and equivalent structures.

1. An electrical connection box mounting bracket comprising:
an elongated frame of sheet material of appropriate strength and rigidity having at least two frame side-members each joined to and spaced apart by at least two frame cross-members;
said frame side-members and said frame cross-members surrounding and defining a central opening;
said frame side-members each having a substantially planar back surface and said frame cross-members each having a substantially planar back surface;
at least one clip slidingly retained on said frame;
said at least one clip spanning said central opening and positionable at any location between said frame cross-members to define at least one connection box mounting opening;
at least one screw tab extending from said clip adapted to accept at least one screw for mounting a connection box to said frame;
said at least one screw tab having a substantially planar bottom surface; and
the bottom surface of said clip screw tab and the back surface of each frame side-member and the back surface of a frame cross-member surrounding a connection box mounting opening are substantially co-planar.

2. The electrical connection box mounting bracket of claim 1 further including:
the bottom surface of said clip screw tab and the back surface of each frame side-member and the back surface of a frame cross-member surrounding a connection box mounting opening are adapted to contact a connection box sidewall edge substantially along the extent of a sidewall edge.

3. The electrical connection box mounting bracket of claim 1 wherein:
said at least two frame side-members are spaced apart by a distance less than about 3.87 inches.

4. The electrical connection box mounting bracket of claim 1 further including:
each said frame cross-member adapted to accept at least one screw for mounting a connection box to said frame.

5. An adjustable electrical connection box mounting bracket comprising:
an elongated frame of sheet material of appropriate strength and rigidity having a rail portion and a track portion;
said rail portion having a pair of elongated rails extending in spaced apart substantially parallel relation from a rail cross-member;
said track portion having a pair of elongated tracks extending in spaced apart substantially parallel relation from a track cross-member;
said pair of tracks each having a folded over portion adapted to accept and retain in sliding relationship one rail of said pair of rails;
said rail portion and said track portion joined in sliding relationship to define a central opening of adjustable size;
at least one clip slidingly retained on said track portion;
said at least one clip spanning said central opening and positionable at any location along said track portion to define at least one connection box mounting opening.

6. The adjustable electrical connection box mounting bracket of claim 5 further including:
said track cross-member adapted to accept at least one screw for mounting a connection box to said frame.

7. The adjustable electrical connection box mounting bracket of claim 5 further including:
said track portion having a substantially planar back surface;
said at least one clip having a substantially planar bottom surface; and
the bottom surface of said clip and the back surface of the track portion are substantially co-planar.

8. The adjustable electrical connection box mounting bracket of claim 5 wherein:
said pair of elongated tracks are spaced apart by a distance less than about 3.87 inches.

9. The adjustable electrical connection box mounting bracket of claim 5 further including:
said track portion having a substantially planar back surface;
said at least one clip having a substantially planar bottom surface;
the bottom surface of said clip and the back surface of said track portion surrounding a connection box mounting opening are adapted to contact a connection box sidewall edge substantially along the extent of a sidewall edge.

10. An electrical connection box comprising:
a rectangular housing of sheet material of appropriate strength and rigidity;
said housing having a substantially flat rectangular bottom from the perimeter of which orthogonally extend a first pair of substantially identical substantially parallel walls and a second pair of substantially identical substantially parallel walls;
said first pair of walls each having an upper edge surface of substantially uniform first height relative to the bottom;
an upper edge surface of each of the second pair of walls having a first end portion, a central portion and a second end portion;
a first tab formed in each of the second pair of walls positioned between the first end portion and the central portion of the upper edge surface and extending from said upper edge surface upward relative to the bottom;
a second tab formed in each of the second pair of walls positioned between the second end portion and the central portion of the upper edge surface and extending from said upper edge surface upward relative to the bottom;
the first end portion and the second end portion of the upper edge surface of each of the second pair of walls having a height substantially equal to said first height;
the central portion of the upper edge surface of each of the second pair of walls having a uniform height substantially equal to said first height plus a distance about equal to but no less than the thickness of 20 gauge galvanized sheet metal;
said first tabs each define a notch having its open end extending from the first end portion of the upper edge surface;
said second tabs each define a notch having its open end extending from the second end portion of the upper edge surface;
each said notch having a substantially uniform height about equal to but no less than the thickness of 20 gauge galvanized sheet metal;
each said notch extending to a terminal wall opposite its open end;
the terminal wall of each first tab and the terminal wall of each second tab define a distance less than about 3.87 inches;
the open end of the notch of each first tab and the open end of the notch of each second tab of each of the second pair of walls defines a distance about equal to but greater than 3.87 inches and defines the maximum distance between any portion of a said first tab and any portion of a said second tab of each wall.

11. The electrical connection box of claim 10 further including:
at least one mounting screw tab having at least one hole adapted to accept and retain a mounting screw for fastening said box to a mounting bracket.

12. An electrical connection box comprising:
a rectangular housing of sheet material of appropriate strength and rigidity;
said housing having a substantially flat rectangular bottom from the perimeter of which orthogonally extend a first pair of substantially identical substantially parallel walls and a second pair of substantially identical substantially parallel walls;
said first pair of walls each having an upper edge surface of substantially uniform first height relative to the bottom;
an upper edge surface of each of the second pair of walls having a first end portion, a central portion and a second end portion;
the first end portion and the second end portion of the upper edge surface of each of the second pair of walls having a height substantially equal to said first height;
the central portion of the upper edge surface of each of the second pair of walls having a height substantially equal to said first height plus a distance about equal to but no less than the thickness of 20 gauge galvanized sheet metal;
the central portion of the upper edge surface of each of the second pair of walls is centered along said upper edge surface and is about equal to but less than 3.87 inches in length.

13. The electrical connection box of claim 12 further including:
at least one mounting screw tab having at least one hole adapted to accept and retain a mounting screw for fastening said box to a mounting bracket.
